(19) United States
(12) Patent Application Publication
(10) Pub. No.: US 2026/0356074 A1
(43) Pub. Date: Nov. 12, 2026

(54) LAMINATE AND DECORATIVE ARTICLE

(71) Applicant: Dai Nippon Printing Co., Ltd., Tokyo (JP)

(72) Inventors: Sakie Furuta, Tokyo (JP); Yoshiyuki Meiki, Tokyo (JP)

(73) Assignee: Dai Nippon Printing Co., Ltd., Tokyo (JP)

(21) Appl. No.: 19/126,096

(22) PCT Filed: Nov. 1, 2023
(86) PCT No.: PCT/JP2023/039527

§ 371 Date: Jun. 23, 2025

(30) Foreign Application Priority Data
Nov. 1, 2022 (JP) 2022-175182

(51) Int. Cl. B32B 3/30; B32B 7/023; B32B 27/00

(52) U.S. Cl. CPC B32B 3/30; B32B 7/023; B32B 27/00; B32B 2250/04; B32B 2250/42; B32B 2307/412; B32B 2451/00

(57) ABSTRACT

Provided is a laminate that manifests different designs when a light source is on and off, the design that is manifest when the light source is off being difficult to see when the light source is on but being visible when the light source is off. A laminate according to the present invention comprises a first principal surface that is to be arranged on an observer side and a second principal surface that is to be arranged on a light source side. The first principal surface has an irregularity shape. The laminate comprises, in order from the first principal surface side, at least a first design layer, a transparent resin layer, and a second design layer. The laminate also comprises a third design layer on the first principal surface side or the second principal surface side of the second design layer.

### TECHNICAL FIELD

The present invention relates to a laminate and a decorative article.

### BACKGROUND ART

Decorative resin molded articles obtained by laminating a decorative sheet on the surface of a resin molded article have been heretofore used for vehicle interior and exterior parts, building interior materials, home electric appliance housings and the like. In manufacture of such a decorative resin molded article, a molding method or the like is used in which a decorative sheet provided with a design in advance is integrated with a resin by injection molding. Typical examples of the molding method include an insert molding method in which a decorative sheet is molded into a three-dimensional shape by a vacuum molding die in advance, the decorative sheet is inserted into an injection molding die, and a fluidized resin is injected into the die to integrate the resin with the decorative sheet.

Decorative resin molded articles obtained by the molding method are used for various applications such as vehicle interior and exterior parts as described above, and have been required to have three-dimensional moldability that ensures applicability to three-dimensional molding, and surface characteristics such as scratch resistance of surfaces, as well as diverse design impressions to respond to recent diversification of the tastes of consumers. For example, development has been made to impart a realistic design feeling to a resin molded article by applying matte tone or irregularities to a specific portion of a picture (for example, PTL 1). As a resin molded article having diverse design impressions, a synthetic resin molded part having a design surface that changes has been prop sed (for example, PTL 2).

Further, a decorative sheet has been proposed which exhibits different designs when a light source is on and off, with the light source being arranged on a side opposite to an observer side with respect to the decorative sheet (for example, PTL 3).

### CITATION LIST

### Patent Literature

PTL 1: Japanese Patent Laid-open Publication No. 2009-132145
PTL 2: Japanese Patent Laid-open Publication No. 2010-125817
PTL 3: Japanese Patent Laid-open Publication No. 2013-14051
PTL 4: Japanese Patent Laid-open Publication No. 2020-49844

### SUMMARY OF INVENTION

### Technical Problem

A laminate is known which exhibits different designs when a light source is on and off as described above.

For example, PTL 4 discloses a laminate which includes a first principal surface that is arranged on an observer side, a second principal surface that is arranged on a light source side, and at least a first design layer, a second design layer and a transparent base material layer in the stated order from a second principal surface side and in which an irregularity shape is provided on a surface of the transparent base material layer on a second design layer side. The laminate is excellent to the extent that a design that is exhibited when a light source is on is not visible when the light source is off, and the design is visible only when the light source is on.

On the other hand, a laminate is desired which exhibits different designs when a light source is on and off and in which a design that is exhibited when the light source is off is hardly visible when the light source is on, and the design is visible when the light source is off.

A main object of the present invention is to provide a laminate which exhibits different designs when a light source is on and off, a design that is exhibited when the light source is off is hardly visible when the light source is on, and the design is visible when the light source is off. Another object of the present invention is to provide a decorative article in which the laminate is used.

### Solution to Problem

The present inventors have extensively conducted studies for solving the above-mentioned problems. As a result, the present inventors have found that a laminate which includes a first principal surface arranged on an observer side and a second principal surface arranged on a light source side and in which the first principal surface has an irregularity shape, the laminate further includes at least a first design layer, a transparent resin layer, and a second design layer in the stated order from the first principal surface side, and a third design layer on the first principal surface side or the second principal surface side of the second design layer, a surface of the second design layer on the first principal surface side is relatively flatter than the irregularity shape of the first principal surface, and the third design layer is partially provided exhibits different designs when the light source is on and off, where a design that is exhibited when the light source is off (specifically, a design based on the irregularity shape of a surface of the laminate on the first principal surface side or a design of the first design layer) is hardly visible when the light source is on, and the design is visible when the light source is off. The present invention has been completed by further conducting studies based on the above-mentioned findings.

That is, the present invention provides an invention having the aspects described below.

Item 1. A laminate including a first principal surface arranged on an observer side and a second principal surface arranged on a light source side, in which
the first principal surface has an irregularity shape,
the laminate includes at least a first design layer, a transparent resin layer, and a second design layer in the stated order from the first principal surface side,
the laminate further includes a third design layer on the first principal surface side or the second principal surface side of the second design layer,
a surface of the second design layer on the first principal surface side is relatively flatter than the irregularity shape of the first principal surface, and
the third design layer is partially provided.

Item: 2. The laminate according to item 1, in which a surface of the transparent resin layer on the first principal surface side has an irregularity shape corresponding to the irregularity shape of the first principal surface.

Item 3. The laminate according to item 1 or 2, further including a surface protective layer on an outermost surface on the first principal surface side.

Item 4. The laminate according to any one of items 1 to 3, further including a transparent base material layer on the second principal surface side of the second design layer and the third design layer.

Item 5. The laminate according to any one of items 1 to 4, in which the laminate has a sheet shape.

Item 6. The laminate according to any one of items 1 to 5, including at least a transparent molded resin layer, the second design layer, the transparent resin layer, and the first design layer in the stated order from the second principal surface side.

Item 7. A decorative article including:
the laminate according to any one of items 1 to 6; and
a light source arranged on a side of the second principal surface of the laminate.

### Advantageous Effects of Invention

According to the present invention, there can be provided a laminate which exhibits different designs when a light source is on and off and in which a design that is exhibited when the light source is off is hardly visible when the light source is on, and the design is visible when the light source is off. Further, according to the present invention, there can be provided a decorative article in which the laminate is used.

### BRIEF DESCRIPTION OF DRAWINGS

FIG. 1 is a schematic sectional view of an example of a laminate of the present invention.

FIG. 2 is a schematic sectional view of an example of a laminate of the present invention.

FIG. 3 is a schematic sectional view of an example of a laminate of the present invention.

FIG. 4 is a schematic sectional view of an example of a laminate of the present invention.

FIG. 5 is a schematic sectional view of an example of a decorative article in which the laminate of the present invention is used.

FIG. 6 is an example of a conceptual diagram of the laminate of the present invention observed from the first principal surface side (observer side) when a light source 30 is on.

FIG. 7 is an example of a conceptual diagram of the laminate of the present invention observed from the first principal surface side (observer side) when the light source 30 is on.

### DESCRIPTION OF EMBODIMENTS

### 1. Laminate

A laminate of the present invention includes a first principal surface arranged on an observer side and a second principal surface arranged on a light source side. The first principal surface has an irregularity shape. The laminate includes at least a first design layer, a transparent resin layer, and a second design layer in the stated order from the first principal surface side. The laminate further includes a third design layer on the first principal surface side or the second principal surface side of the second design layer. A surface of the second design layer on the first principal surface side is relatively flatter than the irregularity shape of the first principal surface. The third design layer is partially provided. The laminate of the present invention, which has such a configuration, thus exhibits different designs when a light source is on and off, where a design that is exhibited when the light source is off (specifically, a design based on the irregularity shape of a surface of the laminate on the first principal surface side or a design of the first design layer) is hardly visible when the light source is on, and the design is visible when the light source is off.

The laminate of the present invention can be preferably used in decoration of surfaces of resin molded articles such as vehicle interior and exterior parts, building interior materials, and home electric appliance housings. Therefore, the laminate of the present invention can be preferably used as a decorative sheet for three-dimensional molding. In particular, when the laminate of the present invention has a sheet shape, the laminate can be molded as a decorative sheet for three-dimensional molding, and laminated to a later-described molded resin layer 5 to suitably form a decorative resin molded article.

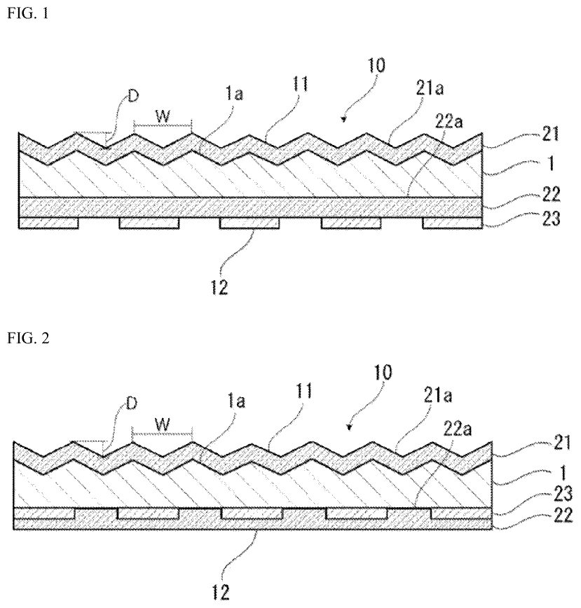

Hereinafter, the laminate of the present invention will be described in detail with reference to FIGS. 1 to 5. In this specification, a numerical range indicated by the term “A to B” means “A or more” and “B or less” unless the numerical range is specified by the term “or more” or “or less”. For example, the expression of “2 to 15 mm” means 2 mm or more and 15 mm or less. In the present description, the “(meth)acrylate” means an “acrylate” or a “methacrylate”, and the same applies to other similar terms.

### Laminated Structure and Irregularity Shape of Decorative Sheet

For example, as shown in FIGS. 1 to 5, a laminate 10 of the present invention includes a first principal surface 11 arranged on the observer side and a second principal surface 12 arranged on the light source side. Specifically, in the use of the laminate 10 of the present invention for applications such as vehicle interior and exterior parts, building interior materials and home electric appliance housings, the first principal surface 11 is arranged on the observer side, and the second principal surface 12 is arranged on the light source side.

The laminate 10 of the present invention includes a laminate including at least a first design layer 21, a transparent resin layer 1 and a second design layer 22 in the stated order from the first principal surface side 11, and a third design layer 23 on the first principal surface 11 side or the second principal surface 12 side of the second design layer 22. In the laminate 10 of the present invention, the first principal surface 11 has an irregularity shape.

When observed from the first principal surface 11 side, the laminate 10 exhibits different designs when the light source 30 is on and off. When the light is off, a design based on the irregularity shape of the surface on the first principal surface 11 side and a design of the first design layer 21 are visible. When the light is on, a design based on the second design layer 22 and the third design layer 23 is visible. In the laminate 10 of the present invention, a design that is exhibited when the light source 30 is off is hardly visible when the light source 30 is on, and the design is visible when the light source is off. For exhibiting such characteristics, it is important that in the laminate 10 of the present invention, the transparent resin layer 1 is arranged between the first design layer 21 and the second design layer 22, and the shape of a surface 22a of the second design layer 22 on the first principal surface 11 side is relatively flatter than the irregularity shape of the first principal surface 11.

The shape of the surface 22a of the second design layer 22 on the first principal surface 11 side is only required to be relatively flatter than the irregularity shape of the first principal surface 11. Specifically, the depth of concave portions of the surface 22a of the second design layer 22 on the first principal surface 11 side is relatively smaller than the depth of concave portions of the irregularity shape of the first principal surface 11. From the viewpoint of more suitably exhibiting the effects of the present invention, it is preferable that the surface 22a of the second design layer 22 on the first principal surface 11 side is substantially flat. For example, the surface 22a of the second design layer 22 on the first principal surface 11 is preferably flat to the extent that the shape thereof does not reflect the irregularity shape of the first principal surface 11, and in this case, the presence of a minor irregularity shape is allowed.

It is preferable that the shape of the surface second design layer 22 on the second principal surface 12 side is relatively flatter than the irregularity shape of the first principal surface 11, more preferably substantially flat.

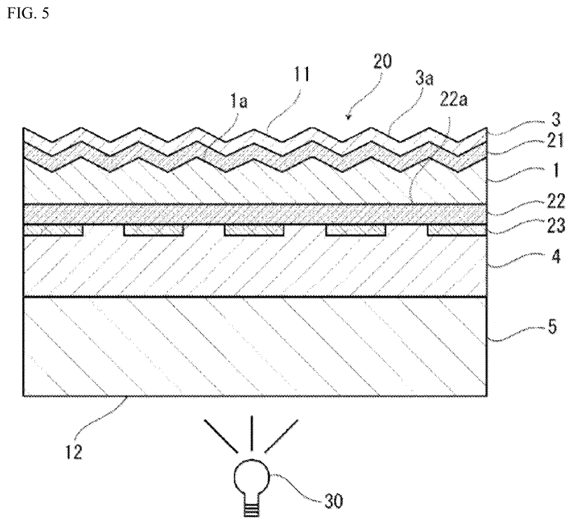

For example, as shown in FIGS. 4 and 5, the laminate 10 of the present invention may further include the surface protective layer 3 on the first design layer 21 (first principal surface 11 side) for the purpose of, for example, imparting surface protection performance for scratch resistance, chemical resistance and the like of a surface. If necessary, a primer layer (not shown) may be provided for the purpose of, for example, improving adhesion between the surface protective layer 3 and a layer situated thereunder (the first design layer 21 or the like). An adhesive layer (not shown) may be provided on, for example, at least one surface of the second design layer 22. Further, when the molded resin layer 5 is laminated on the second principal surface 12 side as shown in, for example, FIG. 5, a back adhesive layer (not shown) may be provided on the second principal surface 12 side of the transparent base material layer 4 (the back surface of the transparent base material layer 4) if necessary for the purpose of improving adhesion between the laminate 10 of the present invention and the molded resin layer 5.

In the laminate of the present invention, one or more other layers may be further laminated according to a function imparted to the laminate or the decorative article.

Examples of the laminated structure of the laminate of the present invention include laminated structures in which the first design layer, the transparent resin layer 1, the second design layer and the third design layer are laminated; the first design layer, the transparent resin layer 1, the third design layer and the second design layer are laminated; the first design layer, the transparent resin layer 1, the second design layer, the third design layer and the transparent base layer are laminated; the first design layer, the transparent resin layer 1, the third design layer, the second design layer and the transparent base layer are laminated; the surface protective layer, the first design layer, the transparent resin layer 1, the second design layer, the third design layer and the transparent base material layer are laminated; the surface protective layer, the first design layer, the transparent resin layer 1, the third design layer, the second design layer and the transparent base material layer are laminated; the surface protective layer, the first design layer, the transparent resin layer 1, the second design layer, the adhesive layer, the third design layer and the transparent base material layer are laminated; the surface protective layer, the first design layer, the transparent resin layer 1, the third design layer, the second design layer, the adhesive layer and the transparent base layer are laminated; the surface protective layer, the first design layer, the transparent resin layer 1, the adhesive layer, the second design layer, the third design layer and the transparent base material layer are laminated; the surface protective layer, the first design layer, the transparent resin layer 1, the third design layer, the adhesive layer, the second design layer and the transparent base material layer are laminated; the surface protective layer, the first design layer, the transparent resin layer 1, the third design layer, the second design layer, the transparent base material layer and the molded resin layer are laminated; the surface protective layer, the first design layer, the transparent resin layer 1, the second design layer, the adhesive layer, the third design layer, the transparent base material layer and the molded resin layer are laminated; the surface protective layer, the first design layer, the transparent resin layer 1, the third design layer, the second design layer, the transparent base material layer, the back adhesive layer and the molded resin layer are laminated; and the surface protective layer, the first design layer, the transparent resin layer 1, the second design layer, the adhesive layer, the third design layer, the transparent base material layer, the back adhesive layer and the molded resin layer are laminated, in the stated order from the first principal surface side.

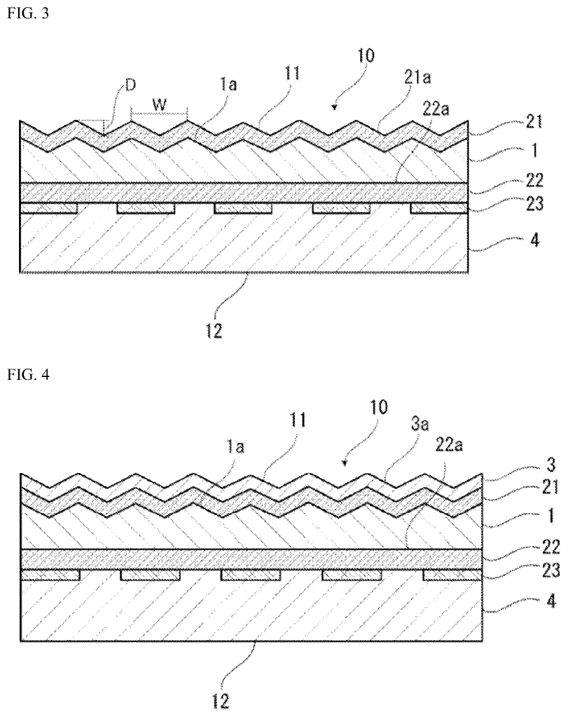

As one aspect of the laminated structure of the laminate of the present invention, FIG. 1 shows a schematic sectional view of an example of a laminate in which the first design layer, the transparent resin layer 1, the second design layer and the third design layer are laminated in the stated order from the first principal surface side. As one aspect of the laminated structure of the laminate of the present invention, FIG. 2 shows a schematic sectional view of an example of a laminate in which the first design layer, the transparent resin layer 1, the third design layer and the second design layer are laminated in the stated order from the first principal surface side. As one aspect of the laminated structure of the laminate of the present invention, FIG. 3 shows a schematic sectional view of an example of a laminate in which the first design layer, the transparent resin layer, the second design layer, the third design layer and the transparent base material layer are laminated in the stated order from the first principal surface side. As one aspect of the laminated structure of the laminate of the present invention, FIG. 4 shows a schematic sectional view of an example of a laminate in which the surface protective layer, the first design layer, the transparent resin layer, the second design layer, the third design layer and the transparent base material layer are laminated in the stated order from the first principal surface side. As one aspect of the laminated structure of the laminate of the present invention, FIG. 5 shows a schematic sectional view of an example of a laminate in which the surface protective layer, the first design layer, the transparent resin layer 1, the second design layer, the third design layer, the transparent base material layer and the molded resin layer are laminated in the stated order from the first principal surface side.

In the laminate 10 of the present invention, a surface of the first design layer 21 on the first principal surface 11 side preferably has an irregularity shape 21a. It is preferable that the shapes of the irregularity shape of the first principal surface 11 and the irregularity shape 21a of a surface of the first design layer 21 on the first principal surface 11 side in the laminate 10 correspond to each other. The irregularity shape 21a of a surface of the first design layer 21 on the first principal surface 11 side coincides with the irregularity shape of the first principal surface 11 when the first design layer 21 forms the first principal surface 11 of the laminate 10 as shown in FIGS. 1 and 2.

In the laminate 10 of the present invention, it is also preferable that a surface of the first design layer 21 on the second principal surface 12 side has an irregularity shape. It is preferable that the irregularity shape 21a of the surface of the first design layer 21 on the first principal surface 11 side corresponds to the irregularity shape of the surface of the first design layer 21 on the second principal surface 12 side as shown in FIGS. 1 and 2.

In the laminate 10 of the present invention, the transparent resin layer 1 may have an irregularity shape. When the transparent resin layer 1 has an irregularity shape, it is preferable that the irregularity shape is provided on the first principal surface 11 side (i.e., an irregularity shape 1a is provided on the first principal surface 11 side of the transparent resin layer 1) as shown in FIGS. 1 to 5. The irregularity shape 1a of the transparent resin layer 1 on the first principal surface side corresponds to, for example, the irregularity shape 21a of a surface of the first design layer 21 on the first principal surface 11 side. That is, in the laminate 10 of the present invention, an irregularity shape corresponding to the irregularity shape of the first principal surface 11 can be provided so as to extend, for example, from the first principal surface 11 to the transparent resin layer 1 (in particular, to a surface of the transparent resin layer 1 on the first principal surface 11 side).

From the viewpoint of more suitably exhibiting the effects of the present invention, the ratio of the depth D of the concave portion of the irregularity shape of the first principal surface 11 to the thickness of the transparent resin layer 1 in the laminate 10 of the present invention is preferably 60% or less, and preferably 10% or more, and is preferably in the range of 10 to 60%.

From the viewpoint of more suitably exhibiting the effects of the present invention, the depth D of the concave portion of the irregularity shape of the first principal surface 11 in the laminate 10 of the present invention is preferably 10 μm or more and 100 μm or less.

The depth of the concave portion can be measured by, for example, cross-sectional observation with a microscope. As shown in FIGS. 1 to 3, the depth D of the convex portion of the irregularity shape of the principal surface is a height from the concave portion to the convex portion in the irregularity shape of the first principal surface 11.

From the same viewpoint, the width W of the concave portion in the irregularity shape of the first principal surface 11 is preferably about 30 to 500 μm, more preferably about 100 to 300 μm. The width W of the concave portion can be measured by, for example, cross-sectional observation with a microscope. As illustrated in FIGS. 1 to 3, the width W of the concave portion is a distance between adjacent convex portions in the irregularity shape of the first principal surface 11.

The irregularity shape of the first principal surface 11 can be suitably formed by, for example, performing embossing. An irregularity shape can be formed on the first principal surface 11 side of the first design layer 21 by, for example, preparing a laminate in which at least the first design layer 21 and the transparent resin layer 1 are laminated, and embossing the laminate on the first principal surface 11 side. Here, adjustment of the depth of the concave portion formed by embossing enables an irregularity shape to be formed in the first design layer 21 and the transparent resin layer 1 by one-time embossing.

The embossing is a known method, for example, a method in which a layer softened by heating is pressed with an embossing plate to form, on the embossing plate, an irregularity pattern, which is transferred to a surface of the laminate, and fixed by cooling. For embossing, a known sheet-type or rotary-type embossing machine can be used.

When other layers such as the surface protective layer 3 and the primer layer are present, an irregularity shape can be formed on these layers by, for example, laminating these layers and the first design layer 21 onto the transparent resin layer 1 to obtain a laminate, on which embossing is performed to form an irregularity shape. In this case, the irregularity shapes formed in the respective layers can be made to coincide. For example, as shown in FIG. 4, the irregularity shape of the surface protective layer 3 corresponds to the irregularity shape of the first design layer 21.

### Layers Forming Laminate

### [First Design Layer 21]

The first design layer 21 is provided on the first principal surface 11 side of the transparent resin layer 1 for the purpose of, for example, imparting decorativeness to the laminate. When the laminate 10 of the present invention is observed from the first principal surface 11 side, the design of the first design layer 21 is visible when the light source 30 on the second principal surface 12 side is off. When the light source 30 is on, the design of the first design layer 21 is hardly visible from the first principal surface 11 side, and the design of the second design layer 22 and the third design layer 23 is visible. On the other hand, when the laminate 10 of the present invention is observed from the first principal surface 11 side, the design of the second design layer 22 and the third design layer 23 is hardly visible when the light source 30 is off.

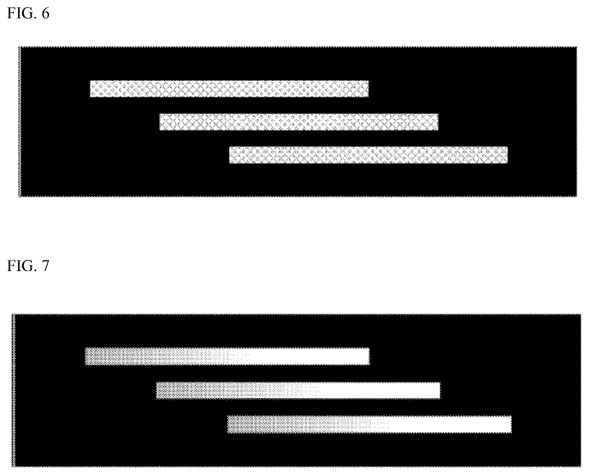

FIGS. 6 and 7 each show a conceptual diagram of the laminate 10 of the present invention observed from the first principal surface 11 side (observer side) when the light source 30 is on. In FIGS. 6 and 7, the black portion is the design of the third design layer 23, and three rectangular portions therein (geometric patterns for FIG. 6 and gray gradation patterns for FIG. 7) are the design of the second design layer 22. The third design layer 23 functions as a light shielding layer that blocks transmission of light, whereas the second design layer functions as a pattern layer that transmits light. The design of the first design layer 21 is hardly visible from the first principal surface 11 side. That is, for example, for FIG. 6, the observer can visually recognize three rectangles which shines while having a geometric pattern. For example, for FIG. 7, the observer can visually recognize three rectangles which shines while having a gradation.

From the viewpoint of further suitably exhibiting the effects of the present invention, it is preferable that a surface of the first design layer 21 on the first principal surface 11 side has the irregularity shape 21a. It is preferable that the irregularity shape of the first principal surface 11 corresponds to the irregularity shape 21a of the surface of the first design layer 21 on the first principal surface 11 side. The irregularity shape 21a of a surface of the first design layer 21 on the first principal surface 11 side coincides with the irregularity shape of the first principal surface 11 when the first design layer 21 forms the first principal surface 11 of the laminate 10 as shown in FIGS. 1 and 2.

In the laminate 10 of the present invention, it is also preferable that a surface of the first design layer 21 on the second principal surface 12 side has an irregularity shape. It is preferable that the irregularity shape 21a of the surface of the first design layer 21 on the first principal surface 11 side corresponds to the irregularity shape of the surface of the first design layer 21 on the second principal surface 12 side as shown in FIGS. 1 and 2.

Since light is scattered by the first design layer 21 having an irregularity shape, the effect of ensuring that the design based on the second design layer 22 and the third design layer 23 is hardly visible when the light is off is easily exhibited.

When the first design layer 21 has an irregularity shape, the irregularity shape may be provided on only the first principal surface 11 side, or may be provided on both the first principal surface 11 side and the second principal surface 12 side as shown in FIGS. 1 to 5.

The first design layer 21 can be, for example, a layer in which a desired picture is formed using an ink composition. For example, it is possible to obtain a configuration in which when the first design layer 21 has a fully monochromatic design, and the second design layer 22 and the third design layer 23 have a patterned design, the fully monochromatic design of the first design layer 21 is visible and the design of the second design layer 22 and the third design layer 23 is not visible when a light source is off, and the patterned design of the second design layer 22 and the third design layer 23 (for example, the above-described pictures such as symbols and character information) is visible when the light source is on.

The first design layer 21 may be partially provided on the transparent resin layer 1, or may be provided on the entire surface of the transparent resin layer 1, and is preferably provided on the entire surface of the transparent resin layer 1.

The first design layer 21 can be formed by, for example, applying a first design layer forming ink onto the transparent resin layer 1 using a heretofore known printing method such as gravure printing, silk screen printing, or offset printing. Examples of the ink composition for use in formation of the first design layer 21, including a binder and a colorant, are as exemplified for the later-described second design layer 22. Examples of the picture formed by the first design layer 21 are as exemplified for the later-described second design layer 22, but the first design layer 21 preferably has a fully monochromatic design as described above.

The first design layer 21 may include a portion composed of a metal thin film. Examples of the metal for forming the metal thin film and the formation method are as exemplified for the second design layer 22.

The thickness of the first design layer 21 is not particularly limited. The lower limit of the thickness is preferably 1 μm or more, and the upper limit of the thickness is preferably 20 μm or less, more preferably 10 μm or less. The thickness is preferably in the range of about 1 to 20 μm or about 1 to 10 μm. When the first design layer 21 has an irregularity shape, the thickness of first design layer 21 is a thickness at the location of the convex portion in the irregularity shape.

From the viewpoint of more suitably exhibiting the effects of the present invention, the optical density (OD value) of the first design layer 22 is preferably 2.5 or less, and preferably 0.3 or more, and is preferably in the range of 0.3 to 2.5. The sum of the OD value of the first design layer and the OD value of the later-described second design layer is preferably less than 3.5.

### [Transparent Resin Layer 1]

The transparent resin layer 1 is provided between the first design layer 21 and the second design layer 22 and third design layer 23, and functions so that a design that is exhibited when the light source 30 is off (for example, the design of the first design layer 21) is hardly visible while the design of the second design layer 22 and the third design layer 23 is easily visible when the light source 30 is on, and a design that is exhibited when the light source 30 is off (for example, the design of the first design layer 21) is easily visible while the design of the second design layer 22 and the third design layer 23 is hardly visible when the light source 30 is off. If the transparent resin layer 1 is not present, for example, a design that is exhibited when the light source 30 is off (for example, the design of the first design layer 21), as well as the design of the second design layer 22 and the third design layer 23, is visible even when the light source 30 is on, and it is thus difficult to achieve the object of the present invention.

As shown in FIG. 5, the transparent resin layer 1 is transparent to the degree that light from the light source 30 can be transmitted when the light source 30 is arranged on the second principal surface 12 side (in the present invention, the term “transparent” includes being translucent). That is, the transparent resin layer 1 is normally transparent (colorless and transparent, colored and transparent, translucent), and may be colored as long as when the laminate 10 of the present invention is observed from the first principal surface 11 side, the design based on the second design layer 22 and the third design layer 23 is visible when the light is on. For example, the transparent resin layer 1 may contain a matting agent such as silica, a colorant, and the like. As the colorant, the colorants exemplified for the later-described second design layer 22 can be used. The transparent resin layer 1 may be, for example, coated for adjusting the color, or patterned for imparting a design property.

As described above, the transparent resin layer 1 may have an irregularity shape. When the transparent resin layer 1 has an irregularity shape, it is preferable that the irregularity shape is provided on the first principal surface 11 side (the irregularity shape 1a is provided on the first principal surface 11 side of the transparent resin layer 1) as shown in FIGS. 1 to 5. The irregularity shape 1a on the first principal surface 11 side of the transparent resin layer 1 corresponds to, for example, the irregularity shape of the first principal surface 11 and the irregularity shape of the first design layer 21. That is, in the laminate 10 of the present invention, the irregularity shape can be provided so as to extend from the first principal surface 11 to the transparent resin layer 1. It is preferable that the shape of a surface of the transparent resin layer 1 on the second principal surface 12 side is relatively flatter than the irregularity shape of the first principal surface 11 of the laminate 10, more preferably substantially flat. When a surface of the transparent resin layer 1 on the second principal surface 12 side is flat, it is preferable that the shape of a layer that is in contact with a surface of the transparent resin layer 1 on the second principal surface 12 side (for example, a surface of the second design layer 22 which is in contact with a surface of the transparent resin layer 1 on the second principal surface 12 side, or a surface of the third design layer 23 which is in contact with a surface of the transparent resin layer 1 on the second principal surface 12 side) is relatively flatter than the irregularity shape of the first principal surface 11 of the laminate 10, more preferably substantially flat. Without being limited, the term “relatively flat” means that the roughness in maximum height, Rz of a surface of the transparent resin layer 1 on the second principal surface 12 side is preferably 50% or less of Rz of the irregularity shape of the first principal surface 11. Rz is measured according to JIS B0601 (1996).

The transparent resin layer 1 can be made from a transparent resin from the viewpoint of suitably exhibiting different designs when the light source is on and off while making the laminate 10 suitable for three-dimensional molding. The transparent resin is preferably formed of a transparent thermoplastic resin. The transparent thermoplastic resin is not particularly limited, and examples thereof include transparent acrylonitrile-butadiene-styrene resin (hereinafter, sometimes referred to as “ABS resin”) and acrylic resin; polyolefin-based resin such as polypropylene and polyethylene; polycarbonate resin; vinyl chloride-based resin; polyethylene terephthalate (PET) resin; and acrylonitrile-styrene-acrylic acid ester resin. The transparent resin layer 1 is preferably formed of transparent acrylic resin among the resins mentioned above. The transparent resin layer 1 may be formed of one type or two or more types of resins.

The thickness of the transparent resin layer 1 is not particularly limited. From the viewpoint of suitably exhibiting different designs when the light source is on and off while making the laminate 10 suitable for three-dimensional molding, the lower limit of the thickness is preferably 50 μm or more, more preferably 70 μm or more, and the upper limit of the thickness is preferably 200 μm or less, more preferably 150 μm or less. The thickness is preferably in the range of about 50 to 200 μm, about 50 to 150 μm, about 70 to 200 μm, or about 70 to 150 μm. When the transparent resin layer 1 has an irregularity shape, the thickness of the transparent resin layer 1 is a thickness at the location of the convex portion in the irregularity shape.

If necessary, one surface or both surfaces of the transparent resin layer 1 may be physically or chemically treated by an oxidation method or a surface roughening method for improving adhesion to adjacent layers. Examples of the oxidation method applied as surface treatment of the transparent resin layer 1 include corona discharge treatment, plasma treatment, chromium oxidation treatment, flame treatment, hot air treatment and ozone ultraviolet treatment methods. Examples of the surface roughening method applied as surface treatment of the transparent resin layer 1 include a sandblasting method and a solvent treatment method. These surface treatments are appropriately selected according to the type of resin forming the transparent resin layer 1, and a corona discharge treatment method is preferable from the viewpoint of an effect, handling characteristics and the like.

From the viewpoint of more suitably exhibiting the effects of the present invention, the total light transmittance of the transparent resin layer 1 is preferably about 70% or more, more preferably about 80% or more, still more preferably about 90% or more. The total light transmittance is measured according to JIS K7361-1 using a haze meter.

### [Second Design Layer 22]

The second design layer 22 is provided on the second principal surface 12 side of the transparent resin layer 1 for the purpose of, for example, imparting decorativeness to the laminate 10. The design of the second design layer 22 is visible from the first principal surface 11 side when the light source on the second principal surface 12 side is on. When the light source 30 is off, the design of the second design layer 22 is hardly visible and the design of the first design layer 21 is visible from the first principal surface 11 side.

The second design layer 22 is provided so as to exhibit a design in cooperation with the later-described third design layer 23 when the light source 30 is on in observation of the laminate 10 of the present invention from the first principal surface 11 side. For example, it is possible to obtain a configuration in which when the second design layer 22 and the third design layer 23 have a patterned design, and the first design layer 21 has a fully monochromatic design, the fully monochromatic design of the first design layer 21 is visible and the design of the second design layer 22 and the third design layer 23 is not visible when the light source 30 is off, and the patterned design of the second design layer 22 and the third design layer 23 (for example, later-described pictures such as symbols and character information) is visible when the light source 30 is on.

The second design layer 22 may be partially provided, or provided on the entire surface, and is preferably provided on the entire surface, when one principal surface of the laminate is assumed to be the entire surface.

The optical density (OD value) of the second design layer 22 is preferably 3.0 or less, and preferably 0.5 or more, and is preferably in the range of 0.5 to 3.0.

The second design layer 22 can be, for example, a layer in which a desired picture is formed using an ink composition. The second design layer 22 can be formed by, for example, applying a second design layer forming ink using a heretofore known printing method such as gravure printing, silk screen printing, or offset printing. As the ink composition for use in formation of the second design layer 22, one obtained by appropriately mixing a binder with a colorant such as a pigment or a dye, an extender pigment, a solvent, a stabilizer, a plasticizer, a catalyst, a curing agent and the like is used.

The binder which is used for the ink composition is not particularly limited, and examples thereof include polyurethane resins, vinyl chloride/vinyl acetate copolymer resins, vinyl chloride/vinyl acetate/acrylic copolymer resins, chlorinated polypropylene resins, acrylic resins, polyester resins, polyamide resins, butyral resins, polystyrene resins, nitrocellulose resins and cellulose acetate resins. These binders may be used alone, or may be used in combination of two or more thereof.

The colorant which is used for the ink composition is not particularly limited, and examples thereof include inorganic pigments such as carbon black (black), iron black, titanium white, antimony white, yellow lead, titanium yellow, rouge, cadmium red, ultramarine and cobalt blue; organic pigments or dyes such as quinacridone red, isoindolinone yellow and phthalocyanine blue; metallic pigments composed of scaly foil pieces of aluminum, brass or the like; and pearlescent (pearl) pigments composed of scaly foil pieces of titanium dioxide-coated mica, basic lead carbonate or the like.

The picture formed by the second design layer 22 is not particularly limited, and examples thereof include symbols, character information, geometric patterns such as dot patterns, line patterns and carbon tones, gradation patterns, woody texture patterns, grainy patterns imitating the surface of rock, such as marble patterns (e.g. travertine marble patterns), fabric patterns imitating grains of fabric or cloth-like patterns, tiling patterns, and brick masonry patterns, and the pattern may be a pattern of a wooden mosaic, a patchwork or the like obtained by combining the above-mentioned patterns, or may be a monochromatic plain pattern (so-called full solid pattern). These pictures are formed by multicolor printing with normal process colors of yellow, red, blue and black, and can also be formed by, for example, multicolor printing with a spot color, which is performed with the preparation of plates of individual colors for forming the pattern.

The second design layer 22 may include a portion composed of a metal thin film. Examples of the metal for forming the thin metal film include tin, indium, chromium, aluminum, nickel, copper, silver, gold, platinum, zinc and an alloy containing at least one of these metals. The method for forming a thin metal film is not particularly limited, and examples thereof include a vapor deposition method such as a vacuum vapor deposition method, a sputtering method and an ion plating method each using the above-mentioned metal. For improving adhesion with the adjacent layer, the surface or back surface of the thin metal film may be provided with a primer layer using a known resin.

As described above, the shape of the surface 22a of the second design layer 22 on the first principal surface 11 side is relatively flatter than the irregularity shape of the first principal surface 11. The shape of the surface 22a of the second design layer 22 on the first principal surface 11 side is only required to be relatively flatter than the irregularity shape of the first principal surface 11. Specifically, the depth of concave portions of the surface 22a of the second design layer 22 on the first principal surface 11 side is relatively smaller than the depth of concave portions of the irregularity shape of the first principal surface 11. From the viewpoint of more suitably exhibiting the effects of the present invention, it is preferable that the surface 22a of the second design layer 22 on the first principal surface 11 side is substantially flat. For example, the surface 22a of the second design layer 22 on the first principal surface 11 is preferably flat to the extent that the shape thereof does not reflect the irregularity shape of the first principal surface 11, and in this case, the presence of a minor irregularity shape is allowed. Without being limited, the term “relatively flat” means that the roughness in maximum height, Rz of a surface of the second design layer 22 side on the first principal surface 11 side is preferably 50% or less of Rz of the irregularity shape of the first principal surface 11. Rz is measured according to JIS B0601 (1996). In a region where the transparent resin layer 1 and the second design layer 22 are in contact with each other, there is a complementary relationship between the shape of a surface of the transparent resin layer on the second principal surface side and a shape of the surface of the second design layer on the first principal surface side.

It is preferable that the shape of the surface of the second design layer 22 on the second principal surface 12 side is relatively flatter than the irregularity shape of the first principal surface 11, more preferably substantially flat. Without being limited, the term “relatively flat” means that the roughness in maximum height, Rz of a surface of the second design layer 22 side on the second principal surface 12 side is preferably 50% or less of Rz of the irregularity shape of the first principal surface 11. Rz is measured according to JIS B0601 (1996).

The thickness of the second design layer 22 is not particularly limited. The lower limit of the thickness is preferably 1 μm or more, and the upper limit of the thickness is preferably 30 μm or less, more preferably 20 μm or less. The thickness is preferably in the range of about 1 to 30 μm or about 1 to 20 μm. When the second design layer 22 has an irregularity shape, the thickness of second design layer 22 is a thickness at the location of the convex portion in the irregularity shape.

### [Third Design Layer 23]

The third design layer 23 is provided on the first principal surface 11 side or the second principal surface 12 side of the second design layer 22 for the purpose of, for example, imparting decorativeness to the laminate 10. Specifically, the third design layer 23 is present between the transparent resin layer 1 and the second design layer 22 when the third design layer 23 is provided on the first principal surface 11 side of the second design layer 22 as shown in FIG. 2. As shown in FIG. 3, the third design layer 23 is present between the second design layer 22 and the transparent base material layer 4 when the laminate 10 includes the later-described transparent base material layer 4, and the third design layer 23 is provided on the second principal surface 12 side of the second design layer 22. When the third design layer 23 is provided on the first principal surface 11 side of the second design layer 22 as shown in FIG. 2, a surface of the second design layer on the first principal surface side is only required to be flatter than the irregularity shape of the first principal surface in a region where the second design layer and the transparent resin layer are in direct contact with each other. That is, a surface of the second design layer 22 on the first principal surface side is only required to be relatively flatter than the irregularity shape of the first principal surface in a region where the third design layer 23 is not provided.

The third design layer 23 is partially provided when a principal surface of the laminate 10 is assumed to be the entire surface. The third design layer 23 is provided so as to exhibit a design in cooperation with the second design layer 22 when the light source 30 is on in observation of the laminate 10 of the present invention from the first principal surface 11 side. As described above, for example, it is possible to obtain a configuration in which when the second design layer 22 and the third design layer 23 have a patterned design, and the first design layer 21 has a fully monochromatic design, the fully monochromatic design of the first design layer 21 is visible and the design of the second design layer 22 and the third design layer 23 is not visible when the light source 30 is off, and the patterned design of the second design layer 22 and the third design layer 23 (for example, later-described pictures such as symbols and character information) is visible when the light source 30 is on.

The optical density (OD value) of the third design layer 23 is preferably 3.5 or more, and preferably 7.0 or less, and is preferably in the range of 3.5 to 7.0.

The third design layer 23 can be formed by, for example, applying a third design layer forming ink using a heretofore known printing method such as gravure printing, silk screen printing, or offset printing. Examples of the ink composition for use in formation of the third design layer 23, including a binder and a colorant, are as exemplified for the above-described second design layer 22.

Examples of the picture formed by the third design layer 23 are as exemplified for the above-described second design layer 22, but it is preferable that the third design layer 23 is formed on a part of the surface, and exhibits an intended design in cooperation with the second design layer 22 as described above.

The third design layer 23 may include a portion composed of a metal thin film. Examples of the metal for forming the metal thin film and the formation method are as exemplified for the second design layer 22.

The thickness of the third design layer 23 is not particularly limited. The lower limit of the thickness is preferably 1 μm or more, and the upper limit of the thickness is preferably 20 μm or less, more preferably 10 μm or less. The thickness is preferably in the range of about 1 to 20 μm or about 1 to 10 μm.

### [Transparent Base Material Layer 4]

The transparent base material layer 4 is provided on the second principal surface 12 side of the second design layer 22 and the third design layer 23 if necessary for imparting rigidity to the laminate 10 to maintain a shape. The transparent base material layer 4 is provided to obtain a laminate 10 suitable for vacuum molding (three-dimensional molding) using an insert molding method or the like.

As shown in FIGS. 3 to 5, the transparent base material layer 4 is transparent to the degree that light from the light source 30 can be transmitted when the light source is arranged on the second principal surface 12 side (in the present invention, the term “transparent” includes being translucent as described above). That is, the transparent base material layer 4 is normally transparent (colorless and transparent, colored and transparent, translucent), and may be colored as long as when the laminate 10 of the present invention is observed from the first principal surface 11 side as long as the design based on the second design layer 22 and the third design layer 23 is visible when the light is on. For example, the transparent base material layer 4 may contain a matting agent such as silica, a colorant, and the like. As the colorant, the colorants exemplified for the above-described second design layer 22 can be used.

The transparent base material layer 4 can be made from a transparent resin, a paper material or the like from the viewpoint of suitably exhibiting different designs when the light source is on and off while making the laminate 10 suitable for three-dimensional molding. The transparent resin is preferably formed of a transparent thermoplastic resin. The transparent thermoplastic resin is not particularly limited, and examples thereof include transparent acrylonitrile-butadiene-styrene resin (hereinafter, sometimes referred to as “ABS resin”) and acrylic resin; polyolefin-based resin such as polypropylene and polyethylene; polycarbonate resin; vinyl chloride-based resin; polyethylene terephthalate (PET) resin; and acrylonitrile-styrene-acrylic acid ester resin. The transparent base material layer 4 is preferably formed of transparent ABS resin among the resins mentioned above. The transparent base material layer 4 may be formed of one type or two or more types of resins.

The thickness of the transparent base material layer 4 is not particularly limited. From the viewpoint of suitably exhibiting different designs when the light source is on and off while making the laminate 10 suitable for three-dimensional molding, the lower limit of the thickness is preferably 50 μm or more, more preferably 100 μm or more, and the upper limit of the thickness is preferably 1,000 μm or less, more preferably 500 μm or less. The thickness is preferably in the range of about 50 to 1,000 μm, or about 100 to 500 μm. More specifically, when transparent ABS resin is used for the transparent base material layer 4, the thickness of the transparent base material layer 4 is more preferably about 100 to 500 μm, still more preferably 200 to 400 μm.

If necessary, one surface or both surfaces of the transparent base material layer 4 may be physically or chemically treated by an oxidation method or a surface roughening method for improving adhesion to adjacent layers. Examples of the oxidation method applied as surface treatment of the transparent base material layer 4 include corona discharge treatment, plasma treatment, chromium oxidation treatment, flame treatment, hot air treatment and ozone ultraviolet treatment methods. Examples of the surface roughening method applied as surface treatment of the transparent base material layer 4 include a sandblasting method and a solvent treatment method. These surface treatments are appropriately selected according to the type of resin forming the transparent base material layer 4, and a corona discharge treatment method is preferable from the viewpoint of an effect, handling characteristics and the like.

### [Surface Protective Layer 3]

The surface protective layer 3 is provided if necessary for protecting a surface of the laminate 10. In the laminate 10, the surface protective layer 3 is provided on an outermost surface on the first principal surface 11 side.

When the laminate 10 includes the surface protective layer 3, an irregularity shape can be formed on the surface protective layer 3 by performing embossing on a laminate of the surface protective layer 3 with the first design layer 21, the transparent resin layer 1 and the like to form an irregularity shape as described below. Thus, the surface protective layer 3 may have an irregularity shape 3a as shown in schematic diagrams of FIGS. 4 and 3. The irregularity shape 3a may be provided on the first principal surface 11 side, or may be provided on both the first principal surface 11 side and the second principal surface 12 side.

From the viewpoint of further suitably exhibiting the effects of the present invention, it is preferable that a surface of the surface protective layer 3 on the first principal surface 11 side has the irregularity shape 3a. It is preferable that the irregularity shape of the first principal surface 11 corresponds to the irregularity shape 3a of the surface of the surface protective layer 3 on the first principal surface 11 side. The irregularity shape 3a of a surface of the surface protective layer 3 on the first principal surface 11 side coincides with the irregularity shape of the first principal surface 11 when the surface protective layer 3 forms the first principal surface 11 of the laminate 10 as shown in FIGS. 4 and 5.

In the laminate 10 of the present invention, the surface protective layer 3 may be provided on the entire surface or partially provided on the first principal surface 11 side. From the viewpoint of suitably protecting a surface of the laminate 10, the surface protective layer 3 is provided on the entire surface on the first principal surface 11 side.

The surface protective layer 3 is normally transparent (colorless and transparent, colored and transparent, translucent), and may be colored or may contain a matting agent such as silica as long as when the laminate 10 of the present invention is observed from the first principal surface 11 side, the design of the second design layer 22 and the third design layer 23 is visible when the light source 30 is on. As the colorant, the colorants exemplified for the above-described first design layer 21 can be used.

The material for forming the surface protective layer 3 is not particularly limited, and examples thereof include thermoplastic resins, thermosetting resins, and ionizing radiation curable resins. In particular, from the viewpoint of improving scratch resistance and the like, the surface protective layer 3 is preferably made from a cured product of an ionizing radiation curable resin composition. The ionizing radiation curable resin for use in formation of the surface protective layer 3 will be described in detail below.

### (Ionizing Radiation Curable Resin)

The ionizing radiation curable resin to be used for formation of the surface protective layer 3 is a resin that is crosslinked and cured when irradiated with an ionizing radiation, and specific examples thereof include those in which at least one of prepolymers, oligomers and monomers each having a polymerizable unsaturated bond or an epoxy group in the molecule is appropriately mixed. Here, the ionizing radiation means an electromagnetic wave or charged particle ray having an energy quantum capable of polymerizing or crosslinking a molecule, and normally an ultraviolet (UV) ray or an electron beam (EB) is used, but the ionizing radiations also include electromagnetic waves such as an X-ray and a Y-ray, and charged particle rays such as an x-ray and an ion beam. Among ionizing radiation curable resins, electron beam-curable resins are suitably used in formation of the surface protective layer 3 because they can be made solventless, do not require an initiator for photopolymerization, and exhibit stable curing characteristics.

As the monomer to be used as an ionizing radiation curable resin, (meth)acrylate monomers having a radical-polymerizable unsaturated group in the molecule are suitable, and among them, polyfunctional (meth)acrylate monomers are preferable. The polyfunctional (meth)acrylate monomer may be a (meth)acrylate monomer having two or more polymerizable unsaturated bonds in the molecule (di- or more functional), preferably three or more polymerizable unsaturated bonds in the molecule (tri- or more functional). Specific examples of the polyfunctional (meth)acrylate include ethylene glycol di(meth)acrylate, propylene glycol di(meth)acrylate, 1,4-butanediol di(meth)acrylate, 1,6-hexanediol di(meth)acrylate, neopentyl glycol di(meth)acrylate, polyethylene glycol di(meth)acrylate, hydroxypivalic acid neopentyl glycol di(meth)acrylate, dicyclopentanyl di(meth)acrylate, caprolactone-modified dicyclopentenyl di(meth)acrylate, ethylene oxide-modified phosphoric acid di(meth)acrylate, allylated cyclohexyl di(meth)acrylate, isocyanurate di(meth)acrylate, trimethylolpropane tri(meth)acrylate, ethylene oxide-modified trimethylolpropane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, tris(acryloxyethyl) isocyanurate, propionic acid-modified dipentaerythritol penta(meth)acrylate, dipentaerythritol hexa(meth)acrylate, ethylene oxide-modified dipentaerythritol hexa(meth)acrylate and caprolactone-modified dipentaerythritol hexa(meth)acrylate. These monomers may be used alone, or may be used in combination of two or more thereof.

As the oligomer to be used as an ionizing radiation curable resin, (meth)acrylate oligomers having a radical-polymerizable unsaturated group in the molecule are suitable, and among them, polyfunctional (meth)acrylate oligomers having two or more polymerizable unsaturated bonds in the molecule (di-or-more functional) are preferable. Examples of the polyfunctional (meth)acrylate oligomer include polycarbonate (meth)acrylate, acrylic silicone (meth)acrylate, urethane (meth)acrylate, epoxy (meth)acrylate, polyester (meth)acrylate, polyether (meth)acrylate, polybutadiene (meth)acrylate, silicone (meth)acrylate, and oligomers having a cation-polymerizable functional group in the molecule (e.g., novolac-type epoxy resins, bisphenol-type epoxy resins, aliphatic vinyl ethers, aromatic vinyl ethers and so on). Here, the polycarbonate (meth)acrylate is not particularly limited as long as it has a carbonate bond on the polymer main chain, and has a (meth)acrylate group at the end or side chain, and the polycarbonate (meth)acrylate can be obtained by esterifying a polycarbonate polyol with (meth)acrylic acid. The polycarbonate (meth)acrylate may be, for example, urethane (meth)acrylate having a polycarbonate backbone. The urethane (meth)acrylate having a polycarbonate backbone is obtained by, for example, reacting a polycarbonate polyol, a polyvalent isocyanate compound and hydroxy (meth)acrylate. The acrylic silicone (meth)acrylate can be obtained by radical-copolymerizing a silicone macro-monomer with a (meth)acrylate monomer. The urethane (meth)acrylate can be obtained by, for example, esterifying a polyurethane oligomer with (meth)acrylic acid, the polyurethane oligomer being obtained by reaction of a polyether polyol or a polyester polyol with a polyisocyanate compound. The epoxy (meth)acrylate can be obtained by, for example, reacting (meth)acrylic acid with an oxirane ring of a relatively low-molecular-weight bisphenol-type epoxy resin or novolac-type epoxy resin to perform esterification. Carboxyl-modified epoxy (meth)acrylate obtained by partially modifying the epoxy (meth)acrylate with a dibasic carboxylic anhydride can also be used. For example, the polyester (meth)acrylate can be obtained by esterifying hydroxyl groups of a polyester oligomer with (meth)acrylic acid, the polyester oligomer being obtained by condensation of a polyvalent carboxylic acid and a polyhydric alcohol and having a hydroxyl group at each of both ends, or by esterifying a hydroxyl group at the end of an oligomer with (meth)acrylic acid, the oligomer being obtained by adding an alkylene oxide to a polyvalent carboxylic acid. The polyether (meth)acrylate can be obtained by esterifying a hydroxyl group of a polyether polyol with (meth)acrylic acid. The polybutadiene (meth)acrylate can be obtained by adding (meth)acrylic acid to the side chain of a polybutadiene oligomer. The silicone (meth)acrylate can be obtained by adding (meth)acrylic acid to the end or side chain of a silicone having a polysiloxane bond in the main chain. These oligomers may be used alone, or may be used in combination of two or more thereof.

Among the ionizing radiation curable resins described above, polycarbonate (meth)acrylate is preferably used from the viewpoint of obtaining further excellent three-dimensional moldability while further improving the visual design impression, abrasion resistance and moldability. It is also preferable to use polycarbonate (meth)acrylate and urethane (meth)acrylate in combination.

### (Other Additive Components)

Various additives can be blended in the surface protective layer 3 according to desired physical properties to be imparted to the surface protective layer 3. Examples of the additives include weather resistance improving agents such as ultraviolet absorbents and light stabilizers, abrasion resistance improvers, polymerization inhibitors, crosslinkers, infrared absorbers, antistatic agents, bondability improvers, leveling agents, thixotropy imparting agents, coupling agents, plasticizers, antifoaming agents, fillers, solvents and colorants. These additives can be appropriately selected from those that are commonly used. As the ultraviolet absorbent and light stabilizer, reactive ultraviolet absorbent and light stabilizer having a polymerizable group sue (meth)acryloyl group in the molecule can also be used.

### (Formation of Surface Protective Layer 3)

The surface protective layer 3 can be formed by, for example, preparing an ionizing-radiation-curable resin composition containing an ionizing-radiation-curable resin, applying the composition to form an uncured resin layer, and crosslinking/curing the uncured resin layer.

The viscosity of the ionizing radiation curable resin composition may be a viscosity that allows an uncured resin layer to be formed by an application method as described later.

In the present invention, the uncured resin layer is applied by a known method such as gravure coating, bar coating, roll coating, reverse roll coating or comma coating, preferably gravure coating, to form an uncured resin layer.

The uncured resin layer formed in this manner is irradiated with an ionizing radiation such as an electron beam or an ultraviolet ray to cure the uncured resin layer, so that the surface protective layer 3 is formed. Here, when an electron beam is used as the ionizing radiation, an accelerating voltage thereof can be appropriately selected according to a resin used and a thickness of the layer, and the accelerating voltage is normally about 70 to 300 kV.

In irradiation of an electron beam, the transmission capacity increases as the accelerating voltage becomes higher, and therefore when a resin that is easily degraded by irradiation of an electron beam is used in a layer under the surface protective layer 3, an accelerating voltage is selected so that the transmission depth of the electron beam is substantially equal to the thickness of the surface protective layer 3. Accordingly, a layer situated under the surface protective layer 3 can be inhibited from being excessively irradiated with an electron beam, so that degradation of the layers by an excessive electron beam can be minimized.

The amount of radiation is preferably an amount with which the crosslinking density of the surface protective layer 3 is saturated, and the amount of radiation is selected within a range of normally 5 to 300 kGy (0.5 to 30 Mrad), preferably 10 to 50 kGy (1 to 5 Mrad).

Further, the electron beam source is not particularly limited, and various kinds of electron beam accelerators can be used such as, for example, those of Cockcroft-Walton type, Van de Graaff type, tuned transformer type, insulated core transformer type, linear type, dynamitron type and high frequency type.

When an ultraviolet ray is used as the ionizing radiation, it is practical to radiate light including an ultraviolet ray having a wavelength of 190 to 380 nm. The ultraviolet ray source is not particularly limited, and examples thereof include high-pressure mercury lamps, low-pressure mercury lamps, metal halide lamps and carbon arc lamps.

The surface protective layer 3 thus formed may be treated to give thereto functions such as a hard coat function, an anticlouding coat function, an antifouling coat function, an antiglare coat function, an antireflection coat function, an ultraviolet shielding coat function and an infrared shielding coat function by adding various kinds of additives.

The thickness of the surface protective layer 3 is not particularly limited. From the viewpoint of imparting surface protection performance for scratch resistance, chemical resistance and the like of a surface, the lower limit of the thickness is preferably 5 μm or more, more preferably 10 μm or more, and the upper limit of the thickness is preferably 30 μm or less, more preferably 20 μm or less. The thickness is preferably in the range of about 5 to 20 μm, about 5 to 10 μm, or about 5 to 15 μm.

### [Primer Layer]

For the purpose of, for example, improving adhesion between the surface protective layer 3 and a layer situated thereunder, a primer layer is provided between the surface protective layer 3 and the first design layer 21 such that the primer layer is in contact with a surface of the surface protective layer 3 on the second principal surface 12 side as necessary.

As the primer composition that forms the primer layer, those having a urethane resin, a (meth)acrylic resin, a (meth)acryl-urethane copolymer resin, a vinyl chloride-vinyl acetate copolymer, a polyester resin, a butyral resin, chlorinated polypropylene, chlorinated polyethylene or the like as a binder resin are preferably used, and these resins can be used alone or in combination of two or more thereof. Among them, urethane resins, (meth)acrylic resins and (meth)acrylic-urethane copolymer resins are preferable.

As the urethane resin, a polyurethane having a polyol (polyhydric alcohol) as a main component and an isocyanate as a crosslinker (curing agent) can be used. The polyol has two or more hydroxyl groups in the molecule, and examples thereof include polyester polyol, polyethylene glycol, polypropylene glycol, acrylic polyol and polyether polyol. Examples of the isocyanate include polyvalent isocyanates having two or more isocyanate groups in the molecule; aromatic isocyanates such as 4,4-diphenylmethane diisocyanate; and aliphatic (or alicyclic) isocyanates such as hexamethylene diisocyanate, isophorone diisocyanate, hydrogenated tolylene diisocyanate and hydrogenated diphenylmethane diisocyanate. It is also possible to mix a urethane resin and a butyral resin.

It is preferable to combine an acrylic polyol or a polyester polyol as a polyol with hexamethylene diisocyanate or 4,4-diphenylmethane diisocyanate as a crosslinker, and it is particularly preferable to use an acrylic polyol and hexamethylene diisocyanate in combination.

Examples of the (meth)acrylic resin include homopolymers of a (meth)acrylic acid ester, copolymers of two or more different (meth)acrylic acid ester monomers, and copolymers of a (meth)acrylic acid ester and another monomer, and specifically, (meth)acrylic resins composed of homopolymers or copolymers including (meth)acrylic acid esters such as polymethyl (meth)acrylate, polyethyl (meth)acrylate, polypropyl (meth)acrylate, polybutyl (meth)acrylate, methyl (meth)acrylate-butyl (meth)acrylate copolymers, ethyl (meth)acrylate-butyl (meth)acrylate copolymers, ethylene-methyl (meth)acrylate copolymers and styrene-methyl (meth)acrylate copolymers are suitably used.

As the (meth)acrylic-urethane copolymer resin, for example, an acryl-urethane (polyester urethane) block copolymer-based resin is preferable. As the curing agent, the above-described various isocyanates are used. It is preferable that in the acryl-urethane (polyester urethane) block copolymer-based resin, the acrylic/urethane ratio (mass ratio) is adjusted within the range of preferably 9/1 to 1/9, more preferably 8/2 to 2/8, as desired.

The thickness of the primer layer is not particularly limited, and is, for example, about 0.5 to 20 μm, preferably about 1 to 5 μm.

Primer layer is formed by a normal coating method such as gravure coating, gravure reverse coating, gravure offset coating, spinner coating, roll coating, reverse roll coating, kiss coating, wheeler coating, dip coating, solid coating with a silk screen, wire bar coating, flow coating, comma coating, pour coating, blushing or spray coating, or a transfer coating method using a primer composition. Here, the transfer coating method is a method in which a coating film of a primer layer or adhesive layer is formed on a thin sheet (film base material), and thereafter the surface of the intended layer in the laminate is coated with the coating film.

### [Adhesive Layer]

An adhesive layer (not shown) is provided if necessary for the purpose of bonding the layers. For example, the adhesive layer is provided on at least one side of the second design layer 22, and can bond the second design layer 22 to the transparent resin layer 1, the third design layer 23, the transparent base material layer 4, or the like.

For the adhesive layer, a thermoplastic resin or a curable resin is used depending on a type of layer bonded.

Examples of the thermoplastic resin which is used for forming the adhesive layer include acrylic resins, acryl-modified polyolefin resins, chlorinated polyolefin resins, vinyl chloride/vinyl acetate copolymers, thermoplastic urethane resins, thermoplastic polyester resins, polyamide resins and rubber-based resins. These thermoplastic resins may be used alone, or may be used in combination of two or more thereof.

Examples of the thermosetting resin for use in formation of the adhesive layer include urethane resins and epoxy resins. These thermosetting resins may be used alone, or may be used in combination of two or more thereof.

Here, the thickness of the adhesive layer is, for example, about 0.1 to 20 μm.

### [Back Adhesive Layer]

When the molded resin layer 5 is provided on the laminate 10, a back adhesive layer (not shown) is provided on the second principal surface 12 side of the transparent base material layer 4 (on a side opposite to the first design layer 21) if necessary for the purpose of improving adhesion to the molded resin layer 5 in molding of the laminate 10.

For the back adhesive layer, a thermoplastic resin or a curable resin is used depending on a type of the molded resin layer 5 which is used for the laminate 10.

Examples of the thermoplastic resin which is used for forming the back adhesive layer include acrylic resins, acryl-modified polyolefin resins, chlorinated polyolefin resins, vinyl chloride/vinyl acetate copolymers, thermoplastic urethane resins, thermoplastic polyester resins, polyamide resins and rubber-based resins. These thermoplastic resins may be used alone, or may be used in combination of two or more thereof.

Examples of the thermosetting resin for use in formation of the back adhesive layer include urethane resins and epoxy resins. These thermosetting resins may be used alone, or may be used in combination of two or more thereof.

The thickness of the back adhesive layer is not particularly limited as long as it is capable of bonding the molded resin layer 5. The thickness is, for example, about 0.1 to 20 μm.

### [Molded Resin Layer 5]

In the laminate 10 of the present invention, the transparent molded resin layer 5 may be integrally formed on the second principal surface 12 side. That is, as shown in FIG. 5, the laminate 10 of the present invention includes a laminate including at least the molded resin layer 5, the second design layer, the transparent resin layer 1 and the first design layer 21 in the stated order, and the third design layer 23 on the first principal surface 11 side or the second principal surface 12 side of the second design layer 22. Like the transparent base material layer 4, the molded resin layer 5 is transparent to the degree that light from the light source 30 can be transmitted when the light source is arranged on the second principal surface 12 side. That is, the molded resin layer 5 is normally transparent (colorless and transparent, colored and transparent, translucent), and may be colored as long as when the laminate 10 of the present invention is observed from the first principal surface 11 side, the design of the second design layer 22 and the third design layer 23 is visible. For example, the molded resin layer 5 may contain a matting agent such as silica, a colorant, and the like. As the colorant, the colorants exemplified for the above-described second design layer 22 can be used.

The molded resin layer 5 can be made from a transparent resin or the like. The transparent resin is preferably formed of a transparent thermoplastic resin. The transparent thermoplastic resin is not particularly limited, and examples thereof include transparent acrylonitrile-butadiene-styrene resin (hereinafter, sometimes referred to as “ABS resin”) and acrylic resin; polyolefin-based resin such as polypropylene and polyethylene; polycarbonate resin; vinyl chloride-based resin; polyethylene terephthalate (PET) resin; and acrylonitrile-styrene-acrylic acid ester resin. The molded resin layer 5 is preferably formed of polycarbonate resin because of excellent transparency among the resins mentioned above. The molded resin layer 5 may be formed of one type or two or more types of resins. As the shape of the molded resin layer 5, a plate-shaped product, a molded product and the like are exemplified.

The laminate 10 including the molded resin layer 5 is prepared by laminating the molded resin layer 5 using a known method. When the molded resin layer 5 is a resin molded product, the molded resin layer 5 may be prepared by an injection molding method such as an insert molding method.

In the insert molding method, first, a laminate before lamination of the molded resin layer 5 (i.e., a laminate including at least the second design layer 22, the transparent resin layer 1 and the first design layer 21 in the stated order from the second principal surface 12 side, and the third design layer 23 on the first principal surface 11 side and the second principal surface 12 side of the second design layer 22) is vacuum molded (off-line premolding) into a molded article surface shape in advance using a vacuum molding die, and an unnecessary portion is then trimmed off if necessary to obtain a molded sheet in a vacuum molding step. The molded sheet is inserted into an injection molding die, the injection molding die is clamped, the fluidized resin is injected into the die from the transparent base material layer 4 side of the laminate, and solidified, and the molded sheet is integrated with the outer surface of the resin molded product in parallel to the injection molding to manufacture the laminate 10 including the molded resin layer 5.

More specifically, the laminate 10 including the molded resin layer 5 is manufactured by an insert molding method including the following steps:
a vacuum molding step of molding a laminate before lamination of the molded resin layer 5 into a three-dimensional shape using a vacuum molding die in advance;
a trimming step of trimming an unnecessary portion of the vacuum-molded laminate to obtain a molded sheet; and
an integration step of inserting the molded sheet into an injection molding die from the transparent base material layer 4 side, closing the injection molding die, and injecting a fluidized resin into the injection molding die to integrate the resin and the molded sheet.

In the vacuum molding step in the insert molding method, the laminate may be heated and molded. The heating temperature at this time is not particularly limited, and may be appropriately selected depending on the type of resin for forming the laminate, the thickness of the laminate, and the like. The heating temperature may be typically about 120 to 200 °C. In the integration step, the temperature of the fluidized resin is not particularly limited, and can be normally set to about 180 °C to 320 °C.

A resin appropriate to an intended use may be selected to form the molded resin layer 5. The molding resin for forming the molded resin layer 5 may be any of the above-described thermoplastic resins or may be a thermosetting resin.

Examples of the thermosetting resin include urethane resins and epoxy resins. These thermosetting resins may be used alone, or may be used in combination of two or more thereof.

The laminate 10 of the present invention, which exhibits different designs when a light source is on and off, thus can be used for, for example, interior materials or exterior materials of vehicles such as automobiles; fittings such as window frames and door frames; interior materials of buildings such as walls, floors and ceilings; housings of household electric appliances such as television receivers and air conditioners; and containers etc. by being combined with a light source.

### [Decorative Article]

A decorative article 20 the resent invention utilizes the laminate 10 of the present invention, and includes the laminate 10 and a light source 30. As shown in FIG. 5, the light source 30 is arranged on a side of the second principal surface 12 of the laminate 10. Details of the laminate 10 of the present invention are as described above.

The type of the light source is not particularly limited, and examples thereof include light emitting diode (LED) bulbs, incandescent bulbs, fluorescent lamps, and natural light.

The decorative article of the present invention, which exhibits different designs when a light source is on and off, thus can be used for, for example, interior materials or exterior materials of vehicles such as automobiles; fittings such as window frames and door frames; interior materials of buildings such as walls, floors and ceilings; housings of household electric appliances such as television receivers and air conditioners; and containers etc.

### EXAMPLE

Hereinafter, the present invention will be described in detail below by showing examples and comparative examples. It is to be noted that the present invention is not limited to examples.

### [Manufacture of Laminate]

### EXAMPLE

A laminate (decorative sheet) was manufactured by the following procedure. On a second principal surface side of a transparent resin layer made from acrylic resin and having a thickness of 125 μm and a total light transmittance of 90%, a geometric pattern layer made from acrylic resin and containing carbon black (black) as a colorant was formed as a second design layer. For measurement of the total light transmittance, a haze/transmittance meter HM-150L2N manufactured by MURAKAMI COLOR RESEARCH LABORATORY CO., LTD was used. Next, as a third design layer, a striped design layer made from acrylic resin and containing carbon black (black) as a colorant was printed. Next, on the first principal surface side of the transparent resin layer, a monochromatic solid layer made from acrylic resin and containing an aluminum metal pigment was formed as a first design layer. Next, a transparent base material layer made from ABS resin was thermally laminated to the third design layer side to obtain a laminate in which a first design layer, a transparent resin layer, a second design layer, a third design layer and a transparent base material layer were laminated in the stated order. Next, embossing was performed on the first design layer side of the obtained laminate using an embossing plate having a geometric pattern and a plate depth of 60 μm, thereby forming an irregularity shape on the first design layer. The decorative sheet of the example includes a first principal surface arranged on an observer side and a second principal surface arranged on a light source side. The first principal surface has an irregularity shape. The laminate includes at least a first design layer, a transparent resin layer, and a second design layer in the stated order from the first principal surface side. The laminate further includes a third design layer on the second principal surface side of the second design layer. A surface of the second design layer on the first principal surface side is relatively flatter than the irregularity shape of the first principal surface. The third design layer is partially provided. In the obtained decorative sheet, the thickness of the transparent resin layer was 125 μm, the depth of concave portions made by embossing was 60 μm, the thickness of the transparent base material layer was 400 μm, the OD value of the first design layer was 0.8, the OD value of the second design layer was 1.2, and the OD value of the third design layer was 6.0. For the measurement of the OD value, a transmittance meter X-rite 341C was used. Rz of the irregularity shape on the first principal surface side was 55 μm as measured according to JIS B0601 (1996). Rz of a surface of the transparent resin layer on the second principal surface side was 3 μm. The cut-off value λc was 0.8 mm. In the present embodiment, the entire surfaces of the transparent resin layer and the second design layer are in contact with each other, and there is a complementary relationship between the shape of a surface of the transparent resin layer on the second principal surface side and a shape of the surface of the second design layer on the first principal surface side.

### COMPARATIVE EXAMPLE

A laminate (decorative sheet) was manufactured by the following procedure. On a first principal surface side of a 475 μm-thick transparent base material layer made from ABS resin, a striped design layer made from acrylic resin and containing carbon black (black) as a colorant was formed as a third design layer, and a geometric pattern layer made from acrylic resin and containing carbon black (black) as a colorant was formed as a second design layer. A monochromatic solid layer made from an acrylic resin and containing an aluminum metal pigment was further formed as a first design layer to obtain a laminate in which a first design layer, a second design layer, a third design layer and a transparent base material layer were laminated in the stated order. Next, embossing was performed on the first design layer side of the obtained laminate using an embossing plate having a geometric pattern and a plate depth of 60 μm, thereby forming an irregularity shape on the first design layer. Unlike the decorative sheet of the example, the decorative sheet of the comparative example does not include a transparent resin layer between the first design layer and the second design layer. In the obtained decorative sheet, the depth of concave portions made by embossing was 60 μm, the thickness of the transparent base material layer was 475 μm, the OD value of the second design layer was 2.2, and the OD value of the third design layer was 6.0. For the measurement of the OD value, a transmittance meter X-rite 341C was used.

[Evaluation of Design Property of Second Design Layer when Light is On]

The decorative sheet (laminate before molding) obtained as described above and a decorative resin molded article (after molding) were visually observed from the surface protective layer side (observation surface dimension: 230.4 mm×135.4 mm), and the appearance when the light was on was visually evaluated on a light panel having a correlated color temperature of 5,200 (±300 K) and an average luminance of 1,500±300 cd/m². The design property of the second design layer when the light was on was evaluated according to the following criteria. Table 1 shows the results.
∘: The design based on the second design layer can be confirmed
x: The design based on the first design layer can be confirmed such that it overlaps the design based on the second design layer
   [Evaluation of Design Property of Third Design Layer when Light is On]

The decorative sheet (laminate before molding) obtained as described above and a decorative resin molded article (after molding) were visually observed from the surface protective layer side (observation surface dimension: 230.4 mm×135.4 mm), and the appearance when the light was on was visually evaluated on a light panel having a correlated color temperature of 5,200 (+300 K) and an average luminance of 1,500±300 cd/m². The design property of the third design layer when the light was on was evaluated according to the following criteria. Table 1 shows the results.
∘: The design based on the third design layer can be confirmed
x: The design based on the first design layer can be confirmed such that it overlaps the design based on the third design layer

TABLE 1

| | | Comparative |
|---|---|---|
| | Example | Example |
| Evaluation of design property of second | ∘ | x |
| design layer when light is on | | |
| Evaluation of design property of third | ∘ | x |
| design layer when light is on | | |

The decorative sheet of the example is a laminate which exhibits different designs when the light source was on and off. When the light source was on, a design that is exhibited when the light source is off (a design based on the first design layer) was hardly visible when the light source was on, and a design based on the second design layer and the third design layer was visible. In the laminate, when the light source was off, the design based on the first design layer was visible, and the design based on the second design layer and the third design layer was hardly visible.

### REFERENCE SIGNS LIST

1 Transparent resin layer
1a Irregularity shape of transparent resin layer on first principal surface side
21 First design layer
21a Irregularity shape of first design layer on first principal surface side
22 Second design layer
22a Surface of second design layer on first principal surface side
23 Third design layer
3 Surface protective layer
3a Irregularity shape of surface protective layer on first principal surface side
4 Transparent base material layer
5 Molded resin lay
10 Laminate
11 First principal surface
11a Irregularity shape on first principal surface side
12 Second principal surface
30 Light source

1. A laminate comprising a first principal surface arranged on an observer side and a second principal surface arranged on a light source side, wherein
the first principal surface has an irregularity shape,
the laminate includes at least a first design layer, a transparent resin layer, and a second design layer in the stated order from the first principal surface side,
the laminate further includes a third design layer on the first principal surface side or the second principal surface side of the second design layer,
a surface of the second design layer on the first principal surface side is relatively flatter than the irregularity shape of the first principal surface, and
the third design layer is partially provided.

2. The laminate according to claim 1, wherein a surface of the transparent resin layer on the first principal surface side has an irregularity shape corresponding to the irregularity shape of the first principal surface.

3. The laminate according to claim 1, further comprising a surface protective layer on an outermost surface on the first principal surface side.

4. The laminate according to claim 1, further comprising a transparent base material layer on the second principal surface side of the second design layer and the third design layer.

5. The laminate according to claim 1, wherein the laminate has a sheet shape.

6. The laminate according to claim 1, comprising at least a transparent molded resin layer, the second design layer, the transparent resin layer, and the first design layer in the stated order from the second principal surface side.

7. A decorative article comprising:
the laminate of claim 1; and
a light source arranged on a side of the second principal surface of the laminate.

8. The laminate according to claim 2, further comprising a surface protective layer on an outermost surface on the first principal surface side.

9. The laminate according to claim 2, further comprising a transparent base material layer on the second principal surface side of the second design layer and the third design layer.

10. The laminate according to claim 2, wherein the laminate has a sheet shape.

11. The laminate according to claim 2, comprising at least a transparent molded resin layer, the second design layer, the transparent resin layer, and the first design layer in the stated order from the second principal surface side.

12. A decorative article comprising:
the laminate of claim 2; and
a light source arranged on a side of the second principal surface of the laminate.
